(19) United States
(12) Patent Application Publication
(10) Pub. No.: US 2010/0208557 A1
(43) Pub. Date: Aug. 19, 2010

(54) Optical Head and Optical Recording Device

(76) Inventors: Manami Kuiseko, Kyoto (JP); Naoki Nishida, Shiga (JP); Kenji Konno, Osaka (JP); Koujirou Sekine, Osaka (JP)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/738,962

(22) PCT Filed: Oct. 9, 2008
(86) PCT No.: PCT/JP2008/068337

§ 371 Date: Apr. 20, 2010

(30) Foreign Application Priority Data
Oct. 29, 2007 (JP) 2007-279754

(51) Int. Cl. G11B 7/00; G11B 7/135; G11B 11/00

(52) U.S. Cl. 369/13.17; 369/100; 369/112.23; G9B/7; G9B/11; G9B/7.112

(57) ABSTRACT

An optical head includes: a slider which moves relative to a recording medium while the slider is floating above the recording medium; an optical waveguide which is provided on a side surface of an end portion of the slider and which has the focusing function of forming a light spot on the recording medium; and a light guide optical system that guides a light pencil to the optical waveguide. A light pencil coupling portion which receives the light pencil from the light guide optical system is provided in a surface parallel to a direction in which the light pencil is guided by the optical waveguide; and a reflective surface which deflects the light pencil to the light pencil coupling portion is provided in the light guide optical system. The light pencil coupling portion has the function of correcting aberration resulting from oblique incidence of the light pencil obliquely incident from the light guide optical system. A medium member which has a refractive index of more than one is provided between the reflective surface and the light pencil coupling portion.

### TECHNICAL FIELD

The present invention relates to an optical head and an optical recording device, for example, an optical-assisted magnetic recording head that utilizes a magnetic field and light to record information and an optical-assisted magnetic recording device incorporating such an optical-assisted magnetic recording head.

### BACKGROUND ART

In a magnetic recording method, as the recording density is increased, magnetic bits are significantly affected by the external temperature and the like. Thus, a recording medium having a high coercivity is needed but the use of such a recording medium requires a high magnetic field at the time of recording. The upper limit of a magnetic field produced by a recording head is determined by its saturation magnetic flux density; since this upper limit is reaching the material limit, it is hopeless to significantly increase it. Hence, there is proposed a method in which, at the time of recording, local heating is conducted to produce magnetic softening and the recording is performed with a decreased coercivity, and thereafter the heating is stopped and natural cooling is performed to ensure the stability of recorded magnetic bits. This method is called a heat-assisted magnetic recording method. In the heat-assisted magnetic recording method, it is preferable to instantaneously heat a recording medium. It is not permissible for a heating mechanism and the recording medium to make contact with each other. Thus, the heating is commonly performed by utilizing the absorption of light; a method of using light to perform heating is called an optical-assisted method.

In patent document 1, as an optical-assisted magnetic recording head, there is proposed a magnetic recording head that is provided with both an optical head portion including a planar waveguide having the function of focusing light and a magnetic head portion for performing magnetic recording on a part to which light emitted from the optical head portion is applied. The planar waveguide is arranged on the end of the head, and is configured to guide parallel light from a light source arranged outside the head into the planar waveguide by using a grating coupler. In patent document 2, as another conventional technology for the optical-assisted magnetic recording head, there is proposed a magnetic recording head in which light pencils guided from the side of a suspension are focused by an optical system to be coupled together on the upper end face (end face opposite from the end face that is located on the side of light emission which faces a recording medium) of a waveguide that is penetrated through the head.

Patent document 1: U.S. Pat. No. 6,944,112
Patent document 2: JP-A-2007-257753

### DISCLOSURE OF THE INVENTION

### Problems to be Solved by the Invention

In the recording head disclosed in patent document 1, it is required to adjust, with high accuracy, the incident angle and the incident position with respect to the grating coupler. However, since the parallel light enters the grating coupler from the side behind the head (the side opposite from the suspension), it is very difficult to adjust the position of a light pencil as the head is moved. This makes it difficult to obtain a high coupling efficiency. Specifically, since the head travels a long distance at the time of recording or reproduction, it is difficult to arrange an optical system with which a light pencil enters the head through the side surface of the end of the head; in order for the optical system to be arranged outside the head, it is necessary to use a mechanism that follows the movement of the optical head, and it is difficult to achieve it with a simple configuration. The same is true for the recording head disclosed in patent document 2. Specifically, since the light focused position on the upper end face of the waveguide needs to coincide with the direction of the optical axis and the in-plane direction, it is required to adjust, with high accuracy, the position of the optical system. Hence, no matter which of the recording heads is used, it is difficult to obtain a high coupling efficiency, and thus it is difficult to obtain a light spot with a high light-use efficiency.

In view of the foregoing circumstances, the present invention is designed, and an object of the present invention is to provide both an optical head with which to obtain a small light spot with a high light-use efficiency without the need to perform adjustment with high accuracy and an optical recording device incorporating such an optical head.

### Means for Solving the Problem

To achieve the above object, according to a first aspect of the present invention or a first invention, there is provided an optical head that utilizes light to record information on a recording medium and that includes: a slider which moves relative to the recording medium while the slider is floating above the recording medium; an optical waveguide which is provided on a side surface of an end portion of the slider and which has a focusing function of forming a light spot on the recording medium; and a light guide optical system that guides a light pencil to the optical waveguide. The optical head further includes: a light pencil coupling portion which receives the light pencil from the light guide optical system and which has a function of correcting aberration resulting from oblique incidence of the light pencil obliquely incident from the light guide optical system, the light pencil coupling portion being arranged in a surface parallel to a direction in which the light pencil is guided by the optical waveguide; and a reflective surface which deflects the light pencil to the light pencil coupling portion, the reflective surface being arranged in the light guide optical system.

According to a second aspect of the present invention or a second invention, in the first invention, the light guide optical system is provided on the slider, and the light pencil that has traveled to the side surface of the end portion of the slider and that has passed above the optical waveguide is returned by the reflective surface such that the light pencil enters the light pencil coupling portion.

According to a third aspect of the present invention or a third invention, in the first invention, the light pencil coupling portion is formed with a grating coupler.

According to a fourth aspect of the present invention or a fourth invention, in the first invention, the light guide optical system makes parallel light or substantially parallel light enter the light pencil coupling portion.

According to a fifth aspect of the present invention or a fifth invention, in the first invention, the light guide optical system has a positive optical power.

According to a sixth aspect of the present invention or a sixth invention, in the first invention, the reflective surface is a planar reflective surface, a curved reflective surface or a diffraction reflective surface.

According to a seventh aspect of the present invention or a seventh invention, there is provided an optical head that utilizes light to record information on a recording medium and that includes: a slider which moves relative to the recording medium while the slider is floating above the recording medium; an optical waveguide which is provided on a side surface of an end portion of the slider and which has a focusing function of forming a light spot on the recording medium; and a light guide optical system that guides a light pencil to the optical waveguide. The optical head further includes: a light pencil coupling portion which receives the light pencil from the light guide optical system, the light pencil coupling portion being arranged in a surface parallel to a direction in which the light pencil is guided by the optical waveguide; a reflective surface which deflects the light pencil to the light pencil coupling portion, the reflective surface being arranged in the light guide optical system; and a medium member which has a refractive index of more than one, the medium member being arranged between the reflective surface and the light pencil coupling portion.

According to an eighth aspect of the present invention or an eighth invention, in the seventh invention, the medium member and the light pencil coupling portion are arranged to come in contact with each other.

According to a ninth aspect of the present invention or a ninth invention, there is provided an optical recording device including: the optical head of any one of the first to eighth inventions; a suspension to which the optical head is fitted; and a light source portion that emits light entering the light guide optical system.

According to a tenth aspect of the present invention or a tenth invention, in the ninth invention, the light source portion includes a semiconductor laser, a condensing lens and an optical fiber.

According to an eleventh aspect of the present invention or an eleventh invention, in the ninth invention, the slider is arranged on an end portion of the suspension, and the light source portion is arranged on a base side of the suspension.

According to a twelfth aspect of the present invention or a twelfth invention, there is provided an optical-assisted magnetic recording head in which the optical head of any one of the first to eighth inventions further includes a magnetic recording element that writes magnetic information on a portion of the recording medium where the light spot is applied.

According to a thirteenth aspect of the present invention or a thirteenth invention, there is provided an optical-assisted magnetic recording device including: the optical-assisted magnetic recording head of the twelfth invention.

### ADVANTAGES OF THE INVENTION

According to the present invention, since a light pencil coupling portion which receives a light pencil from a light guide optical system is provided in an optical waveguide having the function of focusing light, and a reflective surface which deflects the light pencil to the light pencil coupling portion is provided in the light guide optical system, it is possible to obtain a small light spot with a high light-use efficiency without the need to perform adjustment with high accuracy, and it is possible to perform high-density information recording with the light spot. Moreover, since the light pencil coupling portion has the function of correcting aberration resulting from oblique incidence of the light pencil obliquely incident from the light guide optical system, or a medium member having a refractive index of more than one is arranged between the reflective surface and the light pencil coupling portion, it is possible to effectively reduce the sizes of the optical head and the light spot.

### BRIEF DESCRIPTION OF DRAWINGS

FIG. 1 A perspective view schematically showing an example of the configuration of an optical-assisted magnetic recording device;

FIG. 2 A cross-sectional view schematically showing an example of the configuration of an optical-assisted magnetic recording head;

FIG. 3 A plan view showing a specific example of a planar waveguide having the mirror function of focusing light;

FIG. 4 A plan view showing a specific example of a planar waveguide having the lens function of focusing light;

FIG. 5 A schematic diagram showing the shape of a grating coupler provided in the planar waveguide;

FIG. 6 An optical path diagram of a gradient index lens of a light guide optical system;

FIG. 7 A spherical aberration diagram of the gradient index lens shown in FIG. 6;

FIG. 8 A cross-sectional view schematically showing an example of the configuration of an optical head formed by a combination of the gradient index lens and a one-time reflection mirror;

FIG. 9 A cross-sectional view schematically showing an example of the configuration of an optical head formed by a combination of the gradient index lens and a rectangular prism;

FIG. 10 A cross-sectional view schematically showing an example of the configuration of an optical head formed by a combination of the gradient index lens, the rectangular prism and a wedge-shaped fiber;

FIG. 11 A cross-sectional view schematically showing an example of the configuration of an optical head using a spherical reflective mirror;

FIG. 12 A cross-sectional view schematically showing an example of the configuration of an optical head using a diffraction reflective mirror;

FIG. 13 An optical path diagram showing the spherical reflective mirror used in the optical head of FIG. 11;

FIG. 14 A lateral aberration diagram of the spherical reflective mirror of FIG. 13;

FIG. 15 An optical path diagram showing the diffraction reflective mirror used in the optical head of FIG. 12;

FIG. 16 A lateral aberration diagram of the diffraction reflective mirror of FIG. 15;

FIG. 17 A cross-sectional view schematically showing an example of the configuration of an optical head formed by a combination of the gradient index lens and a one-time reflection prism;

FIG. 18 A cross-sectional view schematically showing an example of the configuration of an optical head formed by a combination of the gradient index lens, a two-time reflection prism and the wedge-shaped fiber; and

FIG. 19 A cross-sectional view showing an example of the configuration of the optical head of FIG. 10 in which the rectangular prism comes in contact with a corner of a slider.

### LIST OF REFERENCE SYMBOLS

2 Disc (recording medium)
3 Optical-assisted magnetic recording head (optical head)
7 Optical-assisted magnetic recording device (optical recording device)
8 Slider
8A Planar waveguide (optical waveguide)
8B Magnetic head portion (magnetic recording element, magnetic
reproduction element)
8G Grating coupler (light pencil coupling portion)
8L Low refractive index layer
8H High refractive index layer
8a Planar waveguide having the mirror function of focusing light (optical
waveguide)
8b Planar waveguide having the lens function of focusing light (optical
waveguide)
9 Light guide optical system
9r Reflective surface
9A Gradient index lens (light guide optical system)
9B One-time reflection mirror (light guide optical system)
9b Planar reflective surface (reflective surface)
9C Rectangular prism (light guide optical system)
9c1 Planar reflective surface (reflective surface)
9c2 Planar reflective surface (reflective surface)
9D Wedge-shaped fiber (light guide optical system)
9E Spherical reflective mirror (light guide optical system)
9e Curved reflective surface (reflective surface)
9F Diffraction reflective mirror (light guide optical system)
9f Diffraction reflective surface (reflective surface)
9G One-time reflection prism (light guide optical system)
9g1 Planar reflective surface (reflective surface)
9H Two-time reflection prism (light guide optical system)
9h1 Planar reflective surface (reflective surface)
9h2 Planar reflective surface (reflective surface)
10 Optical fiber (light source portion)
11 Condensing lens (light source portion)
12 Light source (light source portion)
13 Holding member

### BEST MODE FOR CARRYING OUT THE INVENTION

An optical head (for example, an optical-assisted magnetic recording head) according to the present invention, an optical recording device (for example, an optical-assisted magnetic recording device) incorporating such an optical head and the like will be described below with reference to the accompanying drawings. In embodiments, specific examples and the like, like parts and corresponding parts are identified with common symbols, and their description will not be repeated as appropriate.

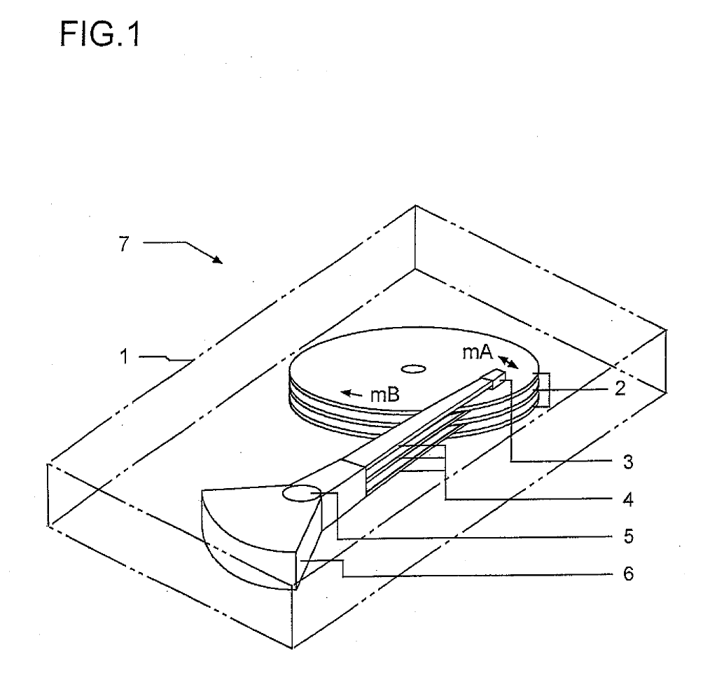

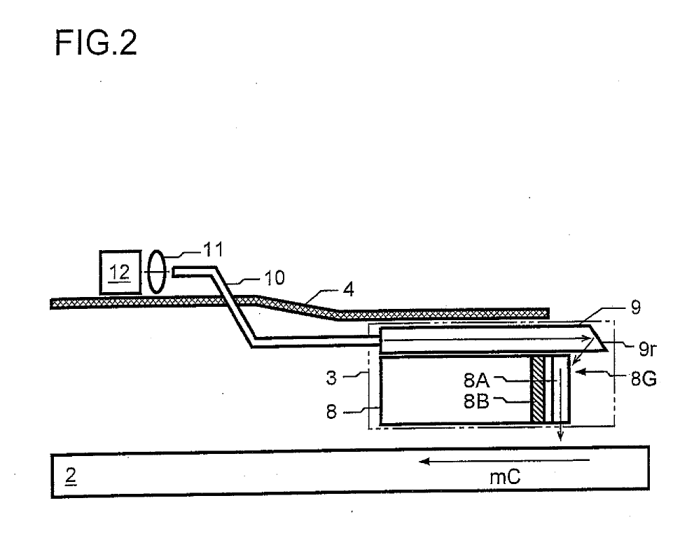

In FIG. 1, an example of the configuration of a magnetic recording device 7 (for example, a hard disk device) incorporating an optical-assisted magnetic recording head 3 is schematically shown. This magnetic recording device 7 includes within its enclosure 1: a recording disk 2 (magnetic recording medium); a suspension 4 provided such that it can rotate about a support shaft 5 in a direction indicated by an arrow mA (tracking direction); an tracking actuator 6 fitted to the suspension 4; the optical-assisted magnetic recording head 3 fitted to the end of the suspension 4; and a motor (not shown) that rotates the disk 2 in a direction indicated by an arrow mB. The magnetic recording device 7 is configured such that the magnetic recording head 3 moves relative to the disk 2 while it is floating above the disk 2 (the disk 2 moves in a direction indicated by an arrow mC in FIG. 2.)

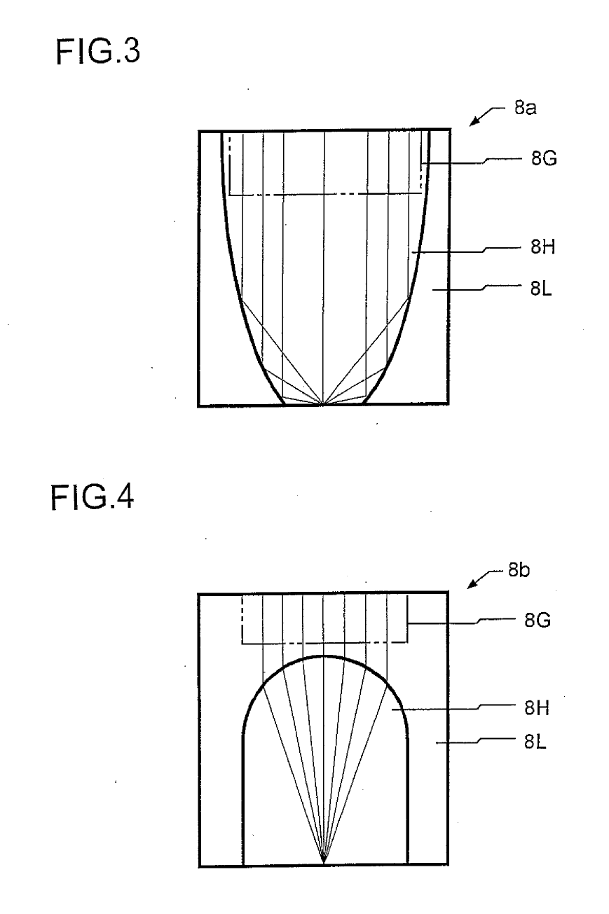

In FIG. 2, an example of the configuration of the magnetic recording head 3 is schematically shown in cross section. This magnetic recording head 3 is a small optical recording head that utilizes light to record information on the disk 2; the magnetic recording head 3 is provided with a slider 8, a light guide optical system 9 and the like. The slider 8 is formed with a substrate; a planar waveguide 8A and a magnetic head portion 8B are formed and arranged in layers within the substrate in this order from the incoming side to the outgoing side of the portion of the disk 2 where recording is performed (in the direction of the arrow mC). The planar waveguide 8A has the function of focusing light to conduct, with near-infrared laser light, spot heating on the portion of the disk 2 where recording is performed (see FIG. 3 or other figures). The magnetic head portion 8B includes at least a magnetic recording element that writes magnetic information on the portion of the disk 2 where recording is performed. For example, when, as in a hard disk device, a device is needed to have the function of magnetic reproduction, a magnetic reproduction element that reads magnetic information recorded on the disk 2 is further included in the magnetic head portion 8B. Although the planar waveguide 8A, the magnetic head portion 8B and the slider 8 are integrally formed, the planar waveguide 8A and the magnetic head portion 8B may be separately formed and be fitted to the slider 8.

On the base side of the suspension 4, a light source portion composed of a light source 12, a condensing lens 11 and an optical fiber 10 is arranged. The light source 12 is a near-infrared light source and is formed with a semiconductor laser; the semiconductor laser emits laser light of a near-infrared wavelength (such as 1550 nm or 1310 nm). The laser light emitted from the light source 12 is condensed by the condensing lens 11, and then passes through the optical fiber 10 and enters the light guide optical system 9 provided on the slider 8. The light guide optical system 9 guides the laser light toward the side surface of the end portion of the slider 8, then uses a reflection function (a reflective surface 9r) to return the laser light that has passed above the planar waveguide 8A and thus makes the laser light enter the planar waveguide 8A. On the side surface of the planar waveguide 8A (that is, the surface parallel to the waveguide direction), a grating coupler 8G that introduces the laser light from the light guide optical system 9 is provided as a light pencil coupling portion. As the laser light that has entered the planar waveguide 8A from the grating coupler 8G approaches the disk 2, the diameter of the light pencil is narrowed by the light focusing function of the planar waveguide 8A, and then it is emitted from the magnetic recording head 3. When the laser light that has been emitted from the planar waveguide 8A is applied as a small light spot to the disk 2, the portion of the disk 2 where the light is applied is temporarily increased in temperature, and thus the coercivity of the disk 2 is lowered. On the light receiving portion having a lowered coercivity, the magnetic head portion 8B writes magnetic information. Instead of the optical fiber 10, an optical waveguide that is formed as necessary may be used.

In FIGS. 3 and 4, specific examples of the planar waveguide 8A are shown. A planar waveguide 8a shown in FIG. 3 is a planar solid immersion mirror (PSIM) that has the mirror function of focusing light; a planar waveguide 8b shown in FIG. 4 is a planar solid immersion lens (PSIL) that has the lens function of focusing light. Each waveguide is configured by placing a high refractive index layer 8H on the substrate and placing a low refractive index layer 8L around it; the laser light is focused by the optical action (that is, the reflection action or the refraction action) of the boundary surface between the high refractive index layer 8H and the low refractive index layer 8L. On the upper portion of the planar waveguide 8a or 8b, the grating coupler 8G is provided as the light pencil coupling portion; the parallel light (substantially parallel light) is introduced into the planar waveguide 8a or 8b through the grating coupler 8G. In other words, the planar waveguides 8a and 8b have not only the light focusing function of narrowing the light pencil as it approaches the disk 2 but also the coupling function of introducing the light pencil from the side surface of the planar waveguides 8a and 8b by using the grating coupler 8G.

On the boundary surface between the high refractive index layer 8H and the low refractive index layer 8L shown in FIG. 3, total reflection occurs due to their difference between the refractive indices. Since the boundary surface is partially shaped substantially in the form of a paraboloidal surface, when the parallel light enters the planar waveguide 8a, the image of the light source is formed in the focus position on the substantially paraboloidal surface. Consequently, the planar waveguide 8a focuses the laser light in one direction due to the mirror effect resulting from the total reflection, and this allows the small light spot to be formed. In the planar waveguide 8b shown in FIG. 4, since the boundary surface between the high refractive index layer 8H and the low refractive index layer 8L is partially shaped in the form of a cylindrical surface, refraction occurs due to the difference between their refractive indices. Since the boundary surface is partially shaped in the form of a cylindrical surface, when the parallel light enters the planar waveguide 8b, the image of the light source is formed in the focus position on the cylindrical surface. Consequently, the planar waveguide 8b focuses the laser light in one direction due to the lens effect resulting from the difference between the refractive indices, and this allows the small light spot to be formed.

With the planar waveguide 8a or 8b having the function of focusing light as described above, it is possible to obtain the small light spot. In the magnetic recording head 3, the planar waveguide 8A is arranged on the end of the head, and the light pencil is introduced, by the grating coupler 8G on the side surface of the end portion of the head, into the optical waveguide, with the result that the light-pencil coupling area can be increased. Hence, as compared with a case where the light pencil is coupled with the width of the optical waveguide with respect to the end of the optical waveguide, the accuracy with which the light guide optical system 9 is arranged can be reduced. This makes it easier to reduce the size of the head as a whole. However, when the grating coupler 8G is used in the planar waveguide 8A, it is required to adjust, with high accuracy, the incident angle and the incident position with respect to the grating coupler 8G. For example, this disadvantageously makes it difficult to obtain a high coupling efficiency.

The light guide optical system 9 (see FIG. 2) is designed to solve this problem. The magnetic recording head 3 shown in FIG. 2 is provided with: the grating coupler 8G that introduces the light pencil from the light guide optical system 9 into the side surface of the planar waveguide 8A having the function of focusing light; and the reflective surface 9r, in the light guide optical system 9, that deflects the light pencil toward the grating coupler 8G. Thus, it is possible to obtain the small light spot with a high light-use efficiency without the need to perform an angle adjustment and a position adjustment with high accuracy. With the light spot, it is possible to perform high-density information recording.

As a portion is closer to the end of the suspension 4, the portion can be brought closer to the portion of the disk 2 where recording is performed. Thus, it is effective to arrange the planar waveguide 8A on the portion of the suspension 4 closer to its end. The structure in which the light pencil is constantly guided in the direction of the end of the suspension 4 can be easily achieved by arranging the slider 8 on the end of the suspension 4 and arranging the light source portion (such as the light source 12) on the side of the base of the suspension 4. In order to perform the optical coupling with the planar waveguide 8A, it is preferable to return, by the reflective surface 9r, the light pencil that has traveled toward the side surface of the end of the slider 8 and that has passed above the planar waveguide 8A and thereby make the light pencil enter the grating coupler 8G.

The effects described above can be achieved by arranging both the light pencil coupling portion that introduces the light pencil from the light guide optical system into the side surface (that is, the surface parallel to the waveguide direction) of the optical waveguide having the function of focusing light, and the reflective surface, in the light guide optical system, that deflects the light pencil toward the light pencil coupling portion. Accordingly, embodiments of such an optical head will be discussed below, and the optical head that allows high-density information recording will be described in further detail. Although the optical head described below is equivalent to the magnetic recording head 3 described above (see FIGS. 1 and 2), the present invention is not limited to this optical head as long as an optical head is used that utilizes light to record information on a recording medium. Specifically, although the magnetic recording head 3 described above is an optical-assisted magnetic recording head that utilizes light to record information on the disk 2, the optical head that utilizes light to record information on the recording medium is not limited to the optical-assisted magnetic recording head. For example, even in an optical head that performs recording such as near-field optical recording or phase-change recording, the unique optical configuration (the light guide optical system 9 and the like) described above is employed, and thus it is possible to obtain the similar effects.

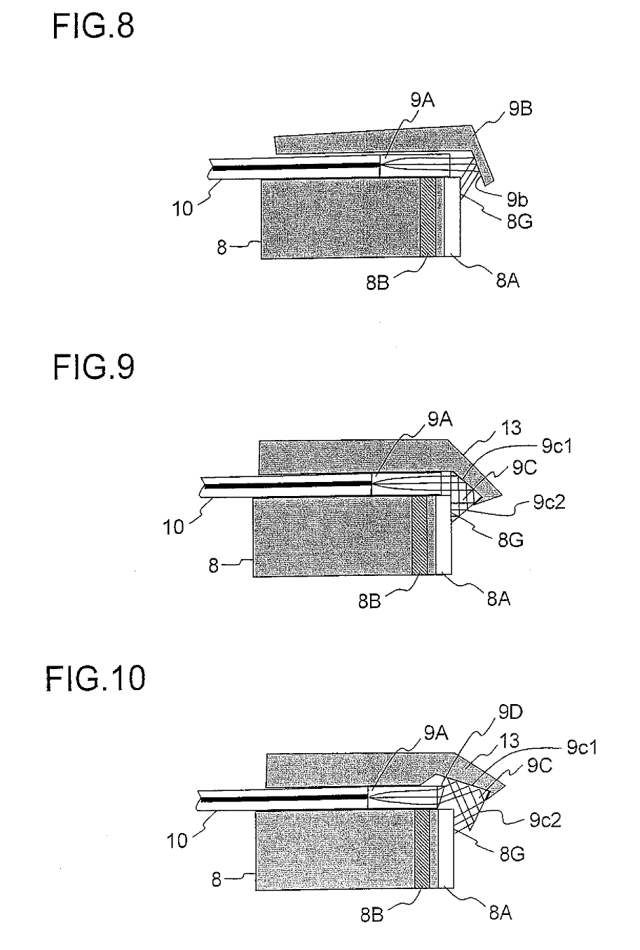

In FIGS. 8 to 10, examples of the configuration of an optical head that converts diverging light emitted from the optical fiber 10 into parallel light (or substantially parallel light) and then deflects it are schematically shown. The optical head shown in FIG. 8 is formed by combining a gradient index lens 9A and a one-time reflection mirror 9B; the optical head shown in FIG. 9 is formed by combining the gradient index lens 9A and a rectangular prism 9C; and the optical head shown in FIG. 10 is formed by combining the gradient index lens 9A, the rectangular prism 9C and a wedge-shaped fiber 9D. In each case, the diverging light emitted from the optical fiber 10 is converted into the parallel light by the gradient index lens 9A, which is a part of the light guide optical system 9 (see FIG. 2).

In the optical head shown in FIG. 8, the parallel light emitted from the gradient index lens 9A is returned by the planar reflective surface 9b of the one-time reflection mirror 9B, which is a part of the light guide optical system 9, and is thus deflected to the grating coupler 8G. When a reflective member, such as the one-time reflection mirror 9B, that reflects the laser light one time and thereby makes it enter the grating coupler 8G is used, the mirror is arranged at a position 0.25 mm away outward from the end of the head and is inclined 15 degrees (that is, an incident angle of 15 degrees with respect to the planar reflective surface 9b), and thus it is possible to make a light pencil having a diameter of 0.1 mm enter the grating coupler 8G at angle of 30 degrees (an incident angle of 30 degrees) from the normal. The one-time reflection mirror 9B is formed integrally with the holding member for the optical fiber 10, and this facilitates reduction in its thickness.

In the optical head shown in FIG. 9, the parallel light emitted from the gradient index lens 9A is returned by the two planar reflective surfaces 9c1 and 9c2 of the rectangular prism 9C, which is a part of the light guide optical system 9, and is thus deflected to the grating coupler 8G. When the parallel light is reflected two times, as in the rectangular prism 9C, the parallel light is preferably reflected two times off inner surfaces. When, as in the optical head shown in FIG. 9, the parallel light enters the grating coupler 8G at a right angle, a louver-shaped diffraction grating is preferably used as the grating coupler 8G where the laser light is introduced into the planar waveguide 8A by total reflection.

When, as in the optical head shown in FIG. 10, the wedge-shaped fiber 9D (or a wedge-shaped prism), which is cut into a wedge shape and has no core, is used, it is possible to incline the light emitted from the optical fiber 10. Accordingly, the rectangular prism 9C can be inclined, and thus it is possible to make the parallel light enter the grating coupler 8G obliquely. The length of the wedge-shaped fiber 9D can be freely set.

When, in the optical heads shown in FIGS. 9 and 10, the rectangular prism 9C obtained by cutting a 0.2 mm cubic prism at an angle of 45 degrees is used, it is possible to bend a light pencil having a diameter of 0.1 mm. Although, in the optical heads shown in FIGS. 9 and 10, the holding member 13 holds both the optical fiber 10 and the rectangular prism 9C, the rectangular prism 9C may be formed integrally with the holding member 13 (at a triangular portion outside the optical path). With this configuration, it is possible to reduce the thickness of the head as a whole. When the light is reflected two times within the rectangular prism, the angle at which the light pencil is emitted with respect to the incoming light pencil is kept constant irrespective of the angle at which the prism is fitted, and thus it is easier to assemble the small head.

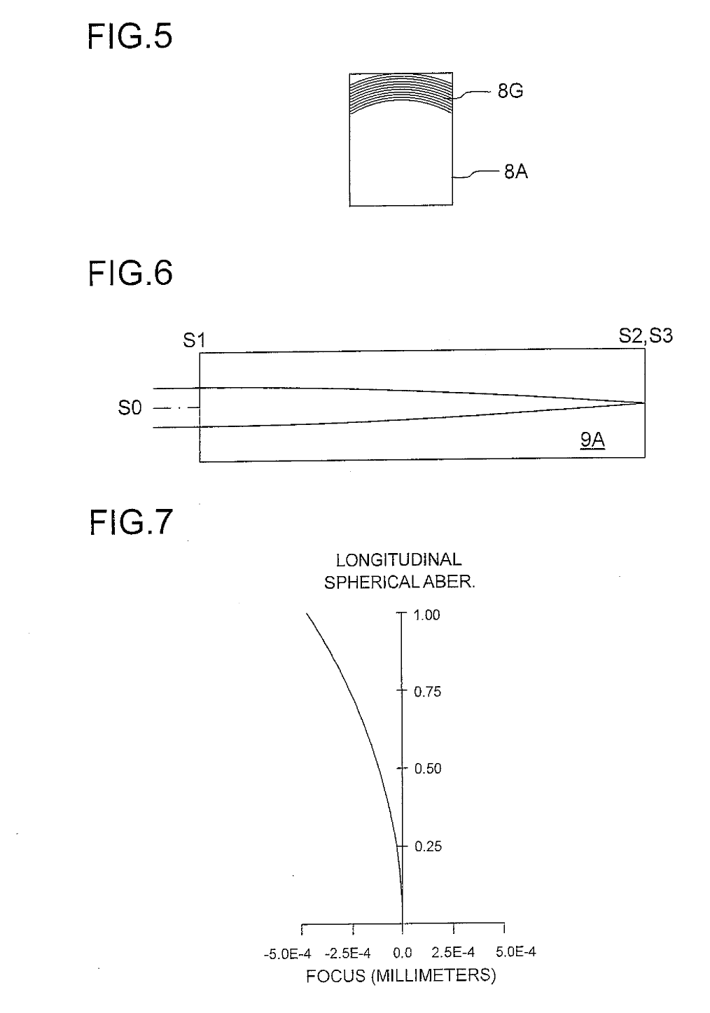

Specific examples of the grating coupler 8G provided in the planar waveguide 8A will now be described. In FIG. 5, the shape of the grating coupler 8G is schematically shown; an example of the grating coupler 8G that is so shaped as to correct aberration resulting from oblique incidence will be discussed below. For example, the phase difference coefficients of the grating when the parallel light enters the grating at an angle of 20 degrees from the normal to its surface are C2: −1.7833E-01, C3: −1.2485E-07 and C5: −1.1025E-07; the phase difference coefficients of the grating when the parallel light enters the grating at an angle of 30 degrees from the normal to its surface are C2: −2.6071E-01, C3: −1.2485E-07 and C5: −1.1025E-07. In a rectangular coordinate system (X, Y, Z), when the direction of the optical axis is considered to be the Z-axis direction and the surface is inclined with respect to the X-axis, the phase difference of the grating in the Z-axis direction is assumed to be expressed by an equation: phase difference P(Z)=C2×Y+C3×X²+C4×X×Y+C5×Y² (the coefficient of a term that is not expressed as data is zero; for all data, E−n=×10⁻ⁿ; the same is true in the following description). As shown in FIG. 5, the physical shape of the grating is formed by placing arcs on top of each other.

When, as in the optical heads shown in FIG. 8 and the like, the light guide optical system makes the light pencil enter the light pencil coupling portion obliquely, the light pencil coupling portion preferably has the function of correcting aberration resulting from the oblique incidence. A grating coupler or the like is generally used to couple a light pencil with a waveguide. A linear grating is preferably provided simply in order for a light pencil to be coupled with a waveguide. However, when a light pencil is coupled with a waveguide, the light pencil is commonly made to enter a grating surface at an angle. When a light pencil is obliquely incident, aberration is produced, and the aberration remains even if the light pencil is narrowed by a waveguide, with the result that a clear point image cannot be formed on a recording surface. Hence, the grating is shaped in the form of an arc corresponding to an incident angle, and thus it is possible to correct aberration resulting from oblique incidence. For example, as the incident angle is greater, the center position for producing a phase difference in the arc of the grating is further displaced from the optical axis, with the result that it is possible to correct the aberration.

As in the optical heads shown in FIGS. 8 to 10, as the light guide optical system 9, a combination of an optical member (the gradient index lens 9A) having a positive optical power and an optical member (the one-time reflection mirror 9B or the rectangular prism 9C) having a reflection function can be used. As an example of the gradient index lens 9A that is used as the optical member having a positive optical power, its construction data is shown below, and its optical path diagram and spherical aberration diagram are shown in FIGS. 6 and 7, respectively. A gradient index material is expressed by an equation: n(r)=n0 [1−{Sqrt(A)×r}²/2] where n represents an refractive index, n0 represents a reference refractive index, Sqrt (A) represents a quadratic constant (unit: mm⁻¹) and r represents a height from the optical axis (in a rectangular coordinate system (x, y, z), when the z-axis direction is considered to be the direction of the optical axis, r²=x²+y².)

Construction Data of the Gradient Index Lens 9A

Unit: mm

| | Radius of | Axial surface | Refractive index |
|---|---|---|---|
| Surface | curvature | distance | (λ = 1000 nm) |
| S0: Outgoing side | INFINITY | INFINITY | |
| S1: Stop surface | INFINITY | 0.500000 | Gradient index |
| | | | material |
| S2: Dummy surface | INFINITY | 0.000000 | |
| S3: Light source side | INFINITY | 0.000000 | |

Specifications

| | |
|---|---|
| Light source side NA | 0.10000 |
| Design wavelength | 1000.00 |
| Magnification | 0 |
| Focal length | 0.2133 |

Gradient index material

| | |
|---|---|
| Reference refractive index | 1.500000 (λ = 1000 nm) |
| sqrt (A) | 0.3125E+01 (λ = 1000 nm) |

As in the optical heads shown in FIG. 8 and the like, the light guide optical system preferably has a positive optical power. When a laser capable of emitting parallel light is used as the light source, it is unnecessary for the light guide optical system to have a positive optical power. However, when a light source that spreads a light pencil as a point light source does is used or when an optical fiber or the like is used as a light source portion, it is necessary to convert the light pencil into parallel light (or substantially parallel light) and guide it to the light pencil coupling portion of a optical waveguide (equivalent to the grating coupler 8G). When a configuration in which the parallel light (or substantially parallel light) is incident is employed, the incident angle of the light with respect to the light pencil coupling portion is set constant, and thus it is possible to achieve a high coupling efficiency.

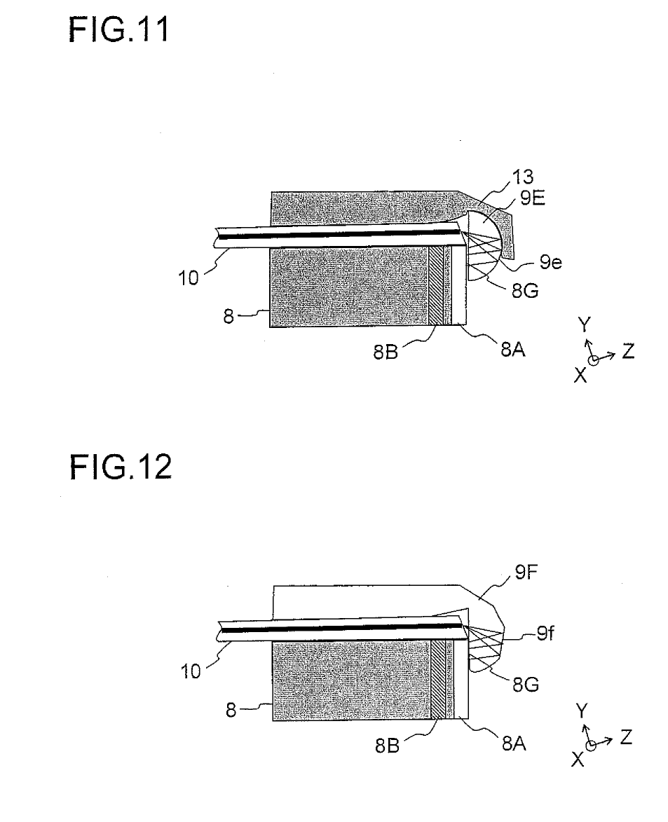

Since light pencils emitted from a laser light source, an optical fiber and the like commonly diverge, when the light guide optical system includes a portion having a positive optical power, it is possible to make the parallel light (or substantially parallel light) enter the light pencil coupling portion. In the optical heads shown in FIGS. 8 to 10, the optical element that has a positive optical power to convert the diverging light into the parallel light (or substantially parallel light) is separate from the optical element that has a reflection function to deflect the laser light. However, even when an optical member having both a positive optical power and a reflection function is used, the same effects can be obtained. In FIGS. 11 and 12, examples of the configuration of optical head provided with the optical member having both a positive optical power and a reflection function are schematically shown.

In the optical head shown in FIG. 11, the light guide optical system 9 (see FIG. 2) is formed with a spherical reflective mirror 9E. The end of the optical fiber 10 is obliquely cut; a direction in which the laser light is emitted is inclined by the inclined end face. The diverging light emitted from the optical fiber 10 enters the spherical reflective mirror 9E, and is deflected by reflection off a curved reflective surface 9e (although a metallic reflective coating is applied to the curved reflective surface 9e, the curved reflective surface 9e may be configured as necessary such that total reflection occurs) and is simultaneously converted into the parallel light (or substantially parallel light). Although, in this optical head, the holding member 13 holds both the optical fiber 10 and the spherical reflective mirror 9E, the spherical reflective mirror 9E may be formed integrally with the holding member 13 (at a portion outside the optical path). With this configuration, it is possible to reduce the thickness of the head as a whole.

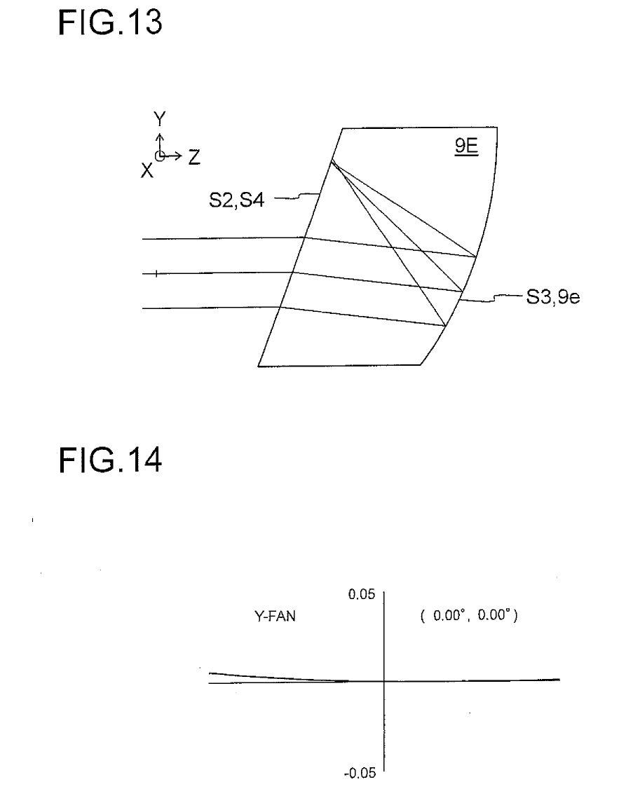

As an example of the spherical reflective mirror 9E that is used as the light guide optical system 9, its construction data is shown below, and its optical path diagram and lateral aberration diagram (showing a lateral aberration (mm) of a tangential light pencil (Y-FAN) at a half-angle of view 0.00°) are shown in FIGS. 13 and 14, respectively. Eccentricity data is expressed based on a local rectangular coordinate system (X, Y, Z). In the rectangular coordinate system (X, Y, Z), the position (mm) of a translational eccentric surface is expressed by a surface vertex coordinate (a translational eccentric position in the X-axis direction, a translational eccentric position in the Y-axis direction and a translational eccentric position in the Z-axis direction) in which the center position of a surface serving as a coordinate reference is defined as the origin (0, 0, 0); the inclination)(°) of the surface is expressed by rotational angles (X-rotation, Y-rotation and Z-rotation) about the surface vertex of the surface with respect to the individual axes.

Construction Data of the Spherical Reflective Mirror 9E

Unit: mm

| | Radius of | Axial surface | Refractive index |
|---|---|---|---|
| Surface | curvature | distance | (λ = 1000 nm) |
| S0: Outgoing side | INFINITY | INFINITY | |
| S1: Dummy surface | INFINITY | 0.200000 | |
| S2: Stop surface | INFINITY | 0.250000 | 1.507502 |

Eccentricity data (local)

| | | | |
|---|---|---|---|
| X-translational | 0.000000 | Y-translational | 0.000000 |
| eccentricity: | | eccentricity: | |
| Z-translational | 0.000000 | Inclination | −20.000000 |
| eccentricity: | | about X-axis: | |
| Inclination | 0.000000 | Inclination | 0.000000 |
| about Y-axis: | | about Z-axis: | |
| S3: Curved | −0.55340 | −0.250000 | −1.507502 |
| reflective surface | | | |

Eccentricity data (local)

| | | | |
|---|---|---|---|
| X-translational | 0.000000 | Y-translational | 0.110122 |
| eccentricity: | | eccentricity: | |
| Z-translational | 0.000000 | Inclination | 0.000000 |
| eccentricity: | | about X-axis: | |
| Inclination | 0.000000 | Inclination | 0.000000 |
| about Y-axis: | | about Z-axis: | |
| S4: Light source side | INFINITY | 0.000000 | |

Specifications

| | |
|---|---|
| Entrance pupil diameter | 0.10000 |
| Design wavelength | 1000.00 nm |
| Image formation magnification | 0.000000 |
| Focal length | −0.2767 |

Instead of the curved reflective surface 9e, a diffractive optical element (such as a DOE (diffractive optical element) or a HOE (holographic optical element)) that reflects and focuses light by diffraction may be used. In the optical head shown in FIG. 12, the light guide optical system 9 (see FIG. 2) is formed with a diffraction reflective mirror 9F that reflects and focuses light by an HOE. The end of the optical fiber 10 is obliquely cut; a direction in which the laser light is emitted is inclined by the inclined end face. The diverging light emitted from the optical fiber 10 enters the diffraction reflective mirror 9F, and is deflected by reflection off a diffraction reflective surface 9f (a metallic reflective coating or the like may be applied thereto as necessary) and is simultaneously converted into the parallel light (or substantially parallel light). The diffraction reflective mirror 9F is formed integrally with the holding member of the optical fiber 10, and this helps reduce the thickness thereof.

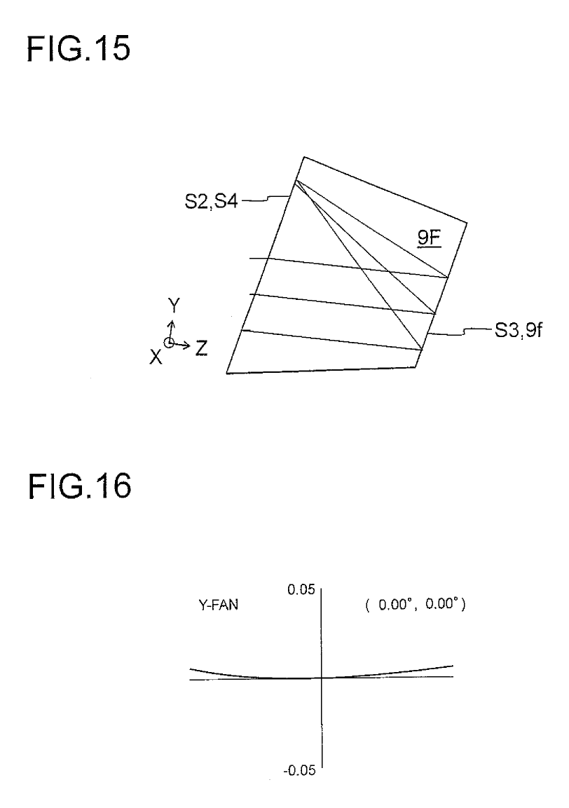

As an example of the diffraction reflective mirror 9F that is used as the light guide optical system 9, its construction data is shown below, and its optical path diagram and lateral aberration diagram (showing a lateral aberration (mm) of a tangential light pencil (Y-FAN) at a half-angle of view 0.00°) are shown in FIGS. 15 and 16, respectively. Eccentricity data is expressed based on a local rectangular coordinate system (X, Y, Z). In the rectangular coordinate system (X, Y, Z), the position (mm) of a translational eccentric surface is expressed by a surface vertex coordinate (a translational eccentric position in the X-axis direction, a translational eccentric position in the Y-axis direction and a translational eccentric position in the Z-axis direction) in which the center position of a surface serving as a coordinate reference is defined as the origin (0, 0, 0); the inclination)(°) of the surface is expressed by rotational angles (X-rotation, Y-rotation and Z-rotation) about the surface vertex of the surface with respect to the individual axes. In the rectangular coordinate system (X, Y, Z), when the direction of the optical axis is considered to be the Z-axis direction and the surface is inclined with respect to the X-axis, the phase difference of the diffractive optical element in the Z-axis direction is expressed by an equation: phase difference P(Z)=C2×Y+C3×X²+C4×X×Y+C5×Y².

Construction Data of the Diffraction Reflective Mirror 9F

Unit: mm

| | Radius of | Axial surface | Refractive index |
|---|---|---|---|
| Surface | curvature | distance | (λ = 1000 nm) |
| S0: Outgoing side | INFINITY | INFINITY | |
| S1: Dummy surface | INFINITY | 0.000000 | |
| S2: Stop surface | INFINITY | 0.250000 | 1.507502 |

Eccentricity data (local)

| | | | |
|---|---|---|---|
| X-translational | 0.000000 | Y-translational | 0.000000 |
| eccentricity: | | eccentricity: | |
| Z-translational | 0.000000 | Inclination | −20.000000 |
| eccentricity: | | about X-axis: | |
| Inclination | 0.000000 | Inclination | 0.000000 |
| about Y-axis: | | about Z-axis: | |
| S3: Diffraction | INFINITY | −0.250000 | −1.507502 |
| reflective surface | | | |
| HOE design | 1000.00 nm | Diffraction | First order |
| wavelength: | | order: | |

HOE phase difference coefficient
C3: −2.7427E+00, C4: 1.2504E−07, C5: −2.3004E+00
Eccentricity data (local)

| | | | |
|---|---|---|---|
| X-translational | 0.000000 | Y-translational | 0.110122 |
| eccentricity: | | eccentricity: | |
| Z-translational | 0.000000 | Inclination | 0.000000 |
| eccentricity: | | about X-axis: | |
| Inclination | 0.000000 | Inclination | 0.000000 |
| about Y-axis: | | about Z-axis: | |
| S4: Light source side | INFINITY | 0.000000 | |

Specifications

| | |
|---|---|
| Entrance pupil diameter | 0.10000 |
| Design wavelength | 1000.00 nm |
| Image formation magnification | 0.000000 |
| Focal length | −0.3277 |

Although the above-described optical heads (FIGS. 2 and 8 to 12) are formed with the combination of the optical fiber 10 with the light guide optical system 9, without the use of a linear optical element such as the optical fiber 10, the optical heads may be formed with a combination of air-propagated light pencils (such as a parallel light pencil and a diverging light pencil) with the light guide optical system 9. For example, instead of the optical fiber 10, a point light source may be arranged; instead of the optical fiber 10 and the gradient index lens 9A, an optical element that emits parallel light may be arranged.

As in the optical heads shown in FIG. 9 and the like, between the light pencil coupling portion (in the optical head of FIG. 9, the grating coupler 8G) and the reflective surface (in the optical head of FIG. 9, the two planar reflective surfaces 9c1 and 9c2 of the rectangular prism 9C) that deflects the light pencil to the light pencil coupling portion, the medium member (in the optical head of FIG. 9, the rectangular prism 9C) having a refractive index of more than one is preferably provided. Moreover, such a medium member (rectangular prism 9C) and the light pencil coupling portion (grating coupler 8G) are preferably arranged to make contact with each other.

When the light pencil emitted from the light source portion (the light source 12 and the like; the primary light source or the secondary light source) is returned by the reflective surface and thus is made to enter the planar waveguide on the side surface of the slider, if the light pencil is a parallel light pencil, the light pencil expands less by diffraction as the length of the optical path is decreased. Hence, between the light pencil coupling portion (equivalent to the grating coupler 8G) and the reflective surface that deflects the light pencil to the light pencil coupling portion, the medium member having a refractive index of more than one is provided, and thus it is possible to reduce the apparent length of the optical path. Even if the light pencil is a substantially parallel light pencil, the light pencil is passed through a medium having a refractive index of more than one, and thus it is possible to correct spherical aberration. This allows the use of a light guide optical system having a high optical power, and thus it is possible to reduce the size of the optical head.

When the light pencil is coupled with the planar waveguide on the side surface of the slider, it is important to accurately position the light guide optical system and the slider. When a light pencil is coupled with a optical waveguide, a coupling loss is somewhat caused irrespective of the use of any coupling component. In order to minimize the loss, it is necessary not only to use a light pencil with the same diameter as a mode diameter to be coupled but also to achieve the coupling in an accurate position. Although it is not difficult to achieve the designed diameter of the light pencil, the positional relationship that is designed cannot be achieved at the time of assembly and this disadvantageously causes the errors of the diameter of the light pencil and the incident position. In the recording head according to the present invention, an extremely small slider about 1 mm long and about 0.5 mm high is used, and thus it is required to perform the positioning with extremely high accuracy.

When the reflective surface is formed with a prism which is made of solid material and in which light is reflected off its inner surfaces, the solid material is brought in contact with the side surface of the slider, and thus it is possible to accurately perform the positioning with respect to the planar waveguide. In a mirror whose reflective surface comes in contact with the air, even if the holding member of the mirror can be positioned with respect to the slider, it is difficult to accurately perform the positioning because the holding member is displaced from the mirror. The medium member that constitutes the reflective surface is also used as a member for performing the positioning, and thus it is possible to achieve both the compactness and the positioning without increasing the number of components.

When the holding member of the light guide optical system (in the optical head of FIG. 9, the rectangular prism 9C) having the reflective surface is mechanically fabricated, the error of the angle is about a few minutes. However, one of the prism surfaces is designed to come in contact with the light pencil coupling portion (in the optical head of FIG. 9, the grating coupler 8G) of the planar waveguide, and thus it is possible to perform the positioning with the same accuracy as in the fabrication of the prism. For example, in the rectangular prism 9C shown in FIG. 9, it is possible to reduce an error to about a few seconds.

When the rectangular prism 9C shown in FIG. 9 is assumed to be a 0.3 mm prism, a light ray passing through it is about 0.42 mm long. Here, when the refractive index of the prism is assumed to be 1.507, the apparent length of the optical path is 0.279 mm. Thus, it is possible to reduce the length by which the width of the light pencil is extended by diffraction to less than 0.01 mm, with the result that the designed coupling efficiency is substantially achieved.

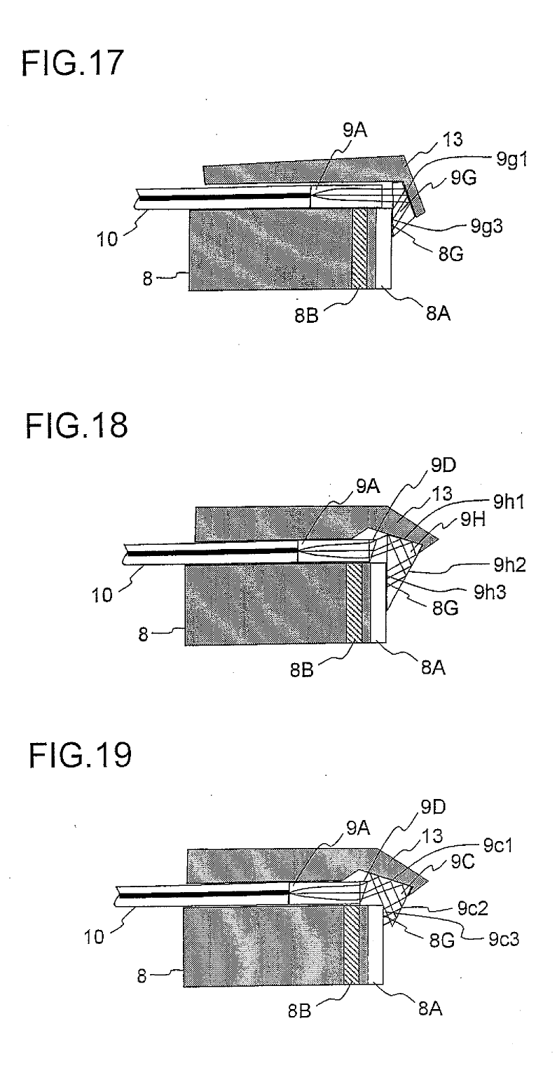

Examples of the configuration of an optical head that is provided with, as in the optical head of FIG. 9, the medium member having a refractive index of more than one between the reflective surface and the light pencil coupling portion are shown in FIGS. 17 and 18. The optical head shown in FIG. 17 is formed with the combination of the gradient index lens 9A and a one-time reflection prism 9G; the optical head shown in FIG. 18 is formed with the combination of the gradient index lens 9A, a two-time reflection prism 9H and the wedge-shaped fiber 9D.

The optical head shown in FIG. 17 has the one-time reflection prism 9G (a planar reflective surface 9g1) as the light guide optical system. Since the light is reflected one time within the prism, as the one-time reflection prism 9G, a prism is preferably used in which the accuracy of the angle between a prism surface 9g3 that comes in contact with the planar waveguide 8A and the prism surface 9g1 serving as the reflective surface is sufficiently low. The angle formed between the planar reflective surface 9g1 and the side surface of the planar waveguide 8A is, for example, 30 degrees.

The optical head shown in FIG. 18 uses the two-time reflection prism 9H (planar reflective surfaces 9h1 and 9h2) as the light guide optical system such that the light is coupled with the planar waveguide 8A at an angle. When the relative angle between the two planar reflective surfaces 9h1 and 9h2 is set at 90 degrees, it is possible to fabricate the prism with relatively high accuracy. Hence, the fabrication is preferably performed with a jig with high accuracy with respect to the angle formed between the prism surface 9h3 that comes in contact with the planar waveguide 8A and any one of the prism reflective surfaces 9b1 and 9h2. The angle formed between the first reflective surface 9h1 and the side surface of the planar waveguide 8A is, for example, 65 degrees.

In the optical head shown in FIG. 10, the planar waveguide 8A and the rectangular prism 9C do not make surface contact with each other. However, for example, as shown in FIG. 19, the light source portion, the optical component (gradient index lens 9A) having an optical power and the rectangular prism 9C are positioned with respect to each other and are fixed by the holding member 13, and then the assembly is performed with the corner of the slider 8 in contact with (in line contact with) the prism surface 9c3. In this way, it is possible to easily perform the positioning in vertical and horizontal directions. That is, the medium member (rectangular prism 9C) is brought in contact with the optical waveguide (planar waveguide 8A), and thus it is possible to easily perform the positioning in a direction in which the light pencil travels (the axial direction of the optical fiber 10).

When, as in the optical head shown in FIG. 11, the spherical reflective mirror 9E is used, it is possible to fabricate the spherical reflective mirror 9E with high accuracy by working a ball lens at the beginning of the fabrication. In the working of the ball lens, since a large number of components can be worked at the same time, it is possible to obtain a lens with an accurate radius of curvature and a high sphericity. Likewise, when planar portions are worked, a large number of components are worked at the same time, and thus it is possible to accurately control their thickness. This allows an error to be significantly reduced as compared with the common method of working the lens. Hence, even a very small lens having a radius of curvature of about 0.5 mm can be accurately fabricated with an error of 0.5λ (λ: wavelength) or less.

In a configuration shown in FIG. 11, the distance by which the light ray passes through the medium is about 0.45 mm. Since the diverging light emitted from the optical fiber 10 is transmitted, it is possible to correct spherical aberration with the curved reflective surface 9e serving as a mirror surface.

When the prism or mirror is arranged to come in contact with the planar waveguide (see FIG. 9 and the like), it is possible to protect the light pencil coupling portion (for example, the grating coupler 8G) of the planar waveguide. When the light pencil coupling portion is exposed to the air, the light pencil coupling portion may be soiled at the time of handling, or dust may adhere thereto while the head is being driven. Since the light pencil coupling portion is often formed with a diffraction grating (for example, the grating coupler 8G) or the like having a minute structure, such stain or dust cannot be easily removed. This type of problem can be solved by coating the surface with the medium member. The diffractive surface does not lose its necessary function even when the solid medium comes in contact with it unless the diffractive surface is covered with adhesive.

1. An optical head that utilizes light to record information on a recording medium and that includes:
a slider which moves relative to the recording medium while the slider is floating above the recording medium;
an optical waveguide which is provided on a side surface of an end portion of the slider and which has a focusing function of forming a light spot on the recording medium; and
a light guide optical system that guides a light pencil to the optical waveguide, the optical head further comprising:
a light pencil coupling portion which receives the light pencil from the light guide optical system and which has a function of correcting aberration resulting from oblique incidence of the light pencil obliquely incident from the light guide optical system, the light pencil coupling portion being arranged in a surface parallel to a direction in which the light pencil is guided by the optical waveguide; and
a reflective surface which deflects the light pencil to the light pencil coupling portion, the reflective surface being arranged in the light guide optical system.

2. The optical head of claim 1,
wherein the light guide optical system is provided on the slider, and the light pencil that has traveled to the side surface of the end portion of the slider and that has passed above the optical waveguide is returned by the reflective surface such that the light pencil enters the light pencil coupling portion.

3. The optical head of claim 1,
wherein the light pencil coupling portion is formed with a grating coupler.

4. The optical head of claim 1,
wherein the light guide optical system makes parallel light or substantially parallel light enter the light pencil coupling portion.

5. The optical head of claim 1,
wherein the light guide optical system has a positive optical power.

6. The optical head of claim 1,
wherein the reflective surface is a planar reflective surface, a curved reflective surface or a diffraction reflective surface.

7. An optical head that utilizes light to record information on a recording medium and that includes:
a slider which moves relative to the recording medium while the slider is floating above the recording medium;
an optical waveguide which is provided on a side surface of an end portion of the slider and which has a focusing function of forming a light spot on the recording medium; and
a light guide optical system that guides a light pencil to the optical waveguide, the optical head further comprising:
a light pencil coupling portion which receives the light pencil from the light guide optical system, the light pencil coupling portion being arranged in a surface parallel to a direction in which the light pencil is guided by the optical waveguide;
a reflective surface which deflects the light pencil to the light pencil coupling portion, the reflective surface being arranged in the light guide optical system; and
a medium member which has a refractive index of more than one, the medium member being arranged between the reflective surface and the light pencil coupling portion.

8. The optical head of claim 7,
wherein the medium member and the light pencil coupling portion are arranged to come in contact with each other.

9. An optical recording device comprising:
the optical head of claim 1;
a suspension to which the optical head is fitted; and
a light source portion that emits light entering the light guide optical system.

10. The optical recording device of claim 9,
wherein the light source portion includes a semiconductor laser, a condensing lens and an optical fiber.

11. The optical recording device of claim 9,
wherein the slider is arranged on an end portion of the suspension, and the light source portion is arranged on a base side of the suspension.

12. An optical-assisted magnetic recording head,
wherein the optical head of claim 1 further includes a magnetic recording element that writes magnetic information on a portion of the recording medium where the light spot is applied.

13. An optical-assisted magnetic recording device comprising:
the optical-assisted magnetic recording head of claim 12.
